(19) United States
(12) Patent Application Publication
(10) Pub. No.: US 2021/0110350 A1
(43) Pub. Date: Apr. 15, 2021

(54) PLATFORM AND METHOD FOR HIRING BASED ON IDENTIFYING AND USING OPTIMAL RECRUITERS

(71) Applicant: HireMojo, Inc., San Francisco, CA (US)

(72) Inventor: John Younger, San Francisco, CA (US)

(21) Appl. No.: 16/597,747

(22) Filed: Oct. 9, 2019

(51) Int. Cl. G06Q 10/10; G06F 9/451; G06Q 40/00; G06Q 10/06

(52) U.S. Cl. CPC G06Q 10/1053; G06F 9/454; G06Q 10/06398; G06Q 10/063112; G06Q 40/125

(57) ABSTRACT

A recruiter dispatch, engagement and income tracking platform is provided that enables a user to enter informational data of the desired job to be filled and select specific recruiters or the next best available recruiters. Selected recruiters are automatically contacted by the system. Such recruiters review ratings of the hiring manager and decide to accept or reject supporting that job. The system shows the recruiter's job search request statuses, income earned, and possible earnings based on filling such jobs. The system monitors and records events such as applicant flow, interview events, and site usage analytics, and suggests alternatives when performance of the job search is determined sub-par. User payment methods are recorded in the system and once the recruiting effort is completed, the hiring manager, recruiter, and/or professional are presented with a screen in the system to rate each other, and the system initiates payment.

### BACKGROUND OF THE INVENTION

### Technical Field

This invention relates generally to a self-service hiring platform. More specifically, this invention relates to a heuristic recruiter share platform where hiring is optimized includes a multi-rating mechanism for recruiter, hiring manager, and profession users to rate one other.

### Description of the Related Art

Presently, fulfilling a job with the best candidate is a time-consuming endeavor. Many obstacles exist not the least of which is how to broadcast that a new job is on the market so that the broadcast reaches the optimally qualified candidates. Therefore, for decades, if not centuries, recruiting agencies have helped shorten the gap of adding a new job and fulfilling it with the optimal applicant. However, even recruiting agencies come with challenges. For example, they can be expensive and they might not have access to the candidates that best suit a job. Also, there is no guarantee that the recruiter is working optimally on the hiring manager's behalf. For example, the recruiter might be on vacation or be swamped with job search requests.

### SUMMARY OF THE INVENTION

A recruiter dispatch, engagement and income tracking platform is provided that enables a user to enter informational data of the desired job to be filled and select specific recruiters or the next best available recruiters. Selected recruiters are automatically contacted by the system. Such recruiters review ratings of the hiring manager and decide to accept or reject supporting that job. The system shows the recruiter's job search request statuses, income earned, and possible earnings based on filling such jobs. The system monitors and records events such as applicant flow, interview events, and site usage analytics, and suggests alternatives when performance of the job search is determined sub-par. User payment methods are recorded in the system and once the recruiting effort is completed, the hiring manager, recruiter, and/or professional are presented with a screen in the system to rate each other, and the system initiates payment.

### BRIEF DESCRIPTION OF THE DRAWINGS

FIG. 1 is a schematic diagram of elements within and outside of the platform, according to an embodiment;

FIG. 2 is a flow diagram for creating and fulfilling an employment position from the hiring manager's system perspective, according to an embodiment;

FIG. 3 is a flow diagram for being invited to and engaging in fulfilling an employment position from the recruiter's system perspective, according to an embodiment;

FIG. 4 is a flow diagram for handling career assets regarding employment positions and managing referrals from the professional's system perspective, according to an embodiment;

FIG. 5 is a sample screen shot of the shared hiring platform application on a mobile device, according to an embodiment;

FIG. 6A is a sample screen shot of the platform's manager home screen, according to an embodiment;

FIG. 6B is a sample screen shot of the platform's manager initiates a new job to be filled screen, according to an embodiment;

FIG. 7 is a sample screen shot of the platform's active jobs screen showing an active job, a recruiter name, and a notification of 15 ranked candidates, according to an embodiment;

FIG. 8A is a sample screen shot of the platform's send an email screen for manager, recruiter, or professional user, according to an embodiment;

FIG. 8B is a sample screen shot of the platform's send a text screen for manager, recruiter, or professional user, according to an embodiment;

FIG. 9 is a sample screen shot of the platform's sign-in page showing high level benefits of the platform, according to an embodiment;

FIG. 10A-B are each a sample screen shot of the platform's sign-in screen, showing that each of the three different type of users can sign in to and use the same platform, according to an embodiment;

FIG. 11A-B are each a sample screen shot of the platform's hiring manager's sign-in page, according to an embodiment;

FIG. 12A is a sample screen shot of the platform's pricing page, according to an embodiment;

FIG. 12B is a sample screen shot of the platform's manager profile page, according to an embodiment;

FIG. 12C is a sample screen shot of the platform's billing information for the manager page, according to an embodiment;

FIG. 13A is a sample screen shot of the platform's hiring manager's page for filling in information about a prospective job showing a specific job tier option being selected and options for types of recruiters to select, according to an embodiment;

FIG. 13B is a sample screen shot of the manager screen showing the manager choosing recruiters to invite, according to an embodiment;

FIG. 13C is a sample screen shot of the manager screen showing recruiter reviews when deciding which recruiters to invite to support the new job, according to an embodiment;

FIG. 14 is a sample screen shot of the platform's hiring manager's page for filling in information about a prospective job showing a specific recruiter from the plurality of recruiters being added to the hiring manager's recruiter invitations, according to an embodiment;

FIG. 15A is a sample screen shot of the platform's hiring manager's page for initiating invitations to recruiters to support the job, according to an embodiment;

FIG. 15B is a sample screen shot of the platform's hiring manager's page for causing the recruiter invitations to be sent, according to an embodiment;

FIG. 15C is a sample screen shot of the platform's hiring manager's home page showing invitations sent out, according to an embodiment;

FIG. 16 shows a sample screen shot of the platform's notification page for a recruiter-user, indicating that the recruiter has received an invitation to support a new job and a link to the details, according to an embodiment;

FIG. 17 is a schematic diagram showing a recruiter user and a hiring manager user and indicating that the recruiter has 12 minutes or less to accept or deny the invitation, showing the near real-time feature provided by the platform, according to an embodiment;

FIG. 18A is a sample screen shot of the platform's hiring manager's page showing a list of active jobs and the relevant details about each job, according to an embodiment;

FIG. 18B is a sample screen shot of manager home screen showing recruiter and candidate information, according to an embodiment;

FIG. 19A is a sample screen shot of the platform's hiring manager's page showing two candidates for a specific job and relevant details related to that candidate, including notes by the recruiter, according to an embodiment;

FIG. 19B is a sample screen shot of the manager views of candidates from the portal, according to an embodiment;

FIG. 19C is a sample screen shot of the manager views of individual candidates in which the view shows recruiter notes and the page allows the user to contact the recruiter directly, according to an embodiment;

FIG. 20A is a sample screen shot of the platform's recruiter sign-in page, according to an embodiment;

FIG. 20B is a sample screen shot of the platform's recruiter home page showing earnings, new requests, current jobs, access to an open new job functionality, and access to a make a referral functionality, according to an embodiment;

FIG. 21A is a schematic diagram showing the current state of a hiring manager and a plurality of recruiters each having specific challenges, as illustrative of a situation which the platform improves, according to an embodiment;

FIG. 21B is a schematic diagram showing how the platform allows the direct transaction of proven and underused assets, e.g., recruiters, among hiring managers, according to an embodiment;

FIG. 22 is a schematic diagram showing how the platform is organized into a recruiter portal, a hiring manager portal, and a talent community member, e.g., professional, portal, according to an embodiment; and

FIG. 23 is a block schematic diagram of a system in the exemplary form of a computer system according to an embodiment.

### DETAILED DESCRIPTION

An automated recruiter dispatch, engagement and income tracking platform or system is provided. An embodiment of such platform includes a computerized system with specialized software that enables a user to enter the title, location and compensation range of the desired job to be filled, then to select specific recruiters or the next best available recruiters from a menu.

Once the system receives job information from a user, selected recruiters are automatically contacted by the system. Such contacted recruiters can review the user reviews and ratings of the hiring manager or other relevant entities, and job criteria. After such review, the recruiter can then make a decision in the system to accept or reject supporting that job.

The system shows each recruiter their active, filled, unfilled, and pending job search requests from users, e.g. hiring managers, along with the income earned and possible earnings based on filling the current active jobs.

For each job's recruiting effort and corresponding user actions, e.g., by the associated hiring manager user, by the recruiter user, and later by the professional user, the system monitors events recorded in the system, applicant or candidate flow, data about interview events, and site usage analytics for each position, suggesting alternatives and course corrections to the user, be it the recruiter, the hiring manager, or the professional, and customer support as appropriate, e.g. if the performance of the job search is sub-par based on benchmarks.

By way of the innovative platform, the current paradigm of trying to find good recruiters is vastly improved upon and such current practices can become a thing of the past. In an embodiment, a recruiter may be considered an asset. And, the notion of inviting a recruiter via an application is novel. By way of this innovative platform, the accountability of all three parties, the hiring manager, the recruiter, and the profession (job candidate) becomes real-time due to sharing technology and based on a real-time multi-directional rating mechanism. Accuracy of placing the right person for the right job also improves because the shared application allows, among other things, referrals from the parties and from contacts of the parties. The architecture of the platform enables real-time dispatching of recruiters to seek candidates for job due in part to the real-time invitational function that may have configured a short (e.g., 12 minutes) deadline to which the recruiter is required to accept or decline the invitation. Also, the innovative architecture of this shared paradigm includes a payment mechanism that ensure that recruiters receive their payment fast (e.g., they can receive a partial payment immediately in real-time after having accepted the invitation). With this platform recruiters, as well as the manager users and the professional users, can depend on consistency. For example, currently, the recruiter relies on the processes of the particular manager for when the recruiter is considered successful and receives payment. In some cases, the recruiter has the burden of having to remind the manager for payment that is due to the recruiter. With the innovative platform, the platform innovatively combines delivering payment automatically in response to a particular threshold parameter, such as a milestone being met (e.g., the manager interviewed 3 candidates recommended by the recruiter) or a condition being met (e.g., the hiring manager making an offer to the candidate), so that the platform solves the problem of inconsistent payment, among other problems. For example, by enabling the parties to rate each other in real-time, the innovative platform provides a central repository of ratings that provides heretofore unknown consistency in the recruiting marketplace and their current systems.

The platform provides multi-lingual, user-friendly menu driven choices based on how the user, e.g. hiring manager, recruiter, or professional, record their language preferences in their respective platform portal. User payment methods are also recorded in the system so that recruiter engagement and job placement fees are collected from the appropriate user, e.g. the hiring manager, using the payment method on file in the system. Once a recruiting effort is recorded in the system as completed, the hiring manager, recruiter, and/or professional are presented with a screen in the system to rate each other, and the system initiates payment to the recruiter for that job if filled.

Further, the innovative platform uniquely supports a marketplace of recruiters, people looking to fill jobs (e.g., hiring managers) and to serve as a place where any professional can store career-centric assets such as but not limited to resumes and reviews throughout their entire career.

The platform supports multiple currencies, geographies, industries, functional areas and job levels around the world.

For the manager, the platform improves the current existing recruitment processes. For example, the platform provides the easiest way to engage with a proven recruiter with documented results and reviews and manages the recruiting process with the least effort, bandwidth, and resources. For the recruiter, the platform improves access to jobs and managers, manages the payment process and provides resources to materially reduce the time and effort to fill jobs for the manager. For the professional, the platform is a trusted place to store career assets such as but not limited to resumes and reviews and where finding a job is easier when there is interest.

In an embodiment, for all roles discussed above, the platform provides a recommendation function that allows users to rate each other at the completion of each recruiting effort.

It should be appreciated that in an embodiment, the platform provides access to the functionality, communication, and data in real-time. That is, in an embodiment, the platform is configured to share recruiting informational data and functionality among the users, e.g., manager, recruiter, and professional, the payment portals in real-time.

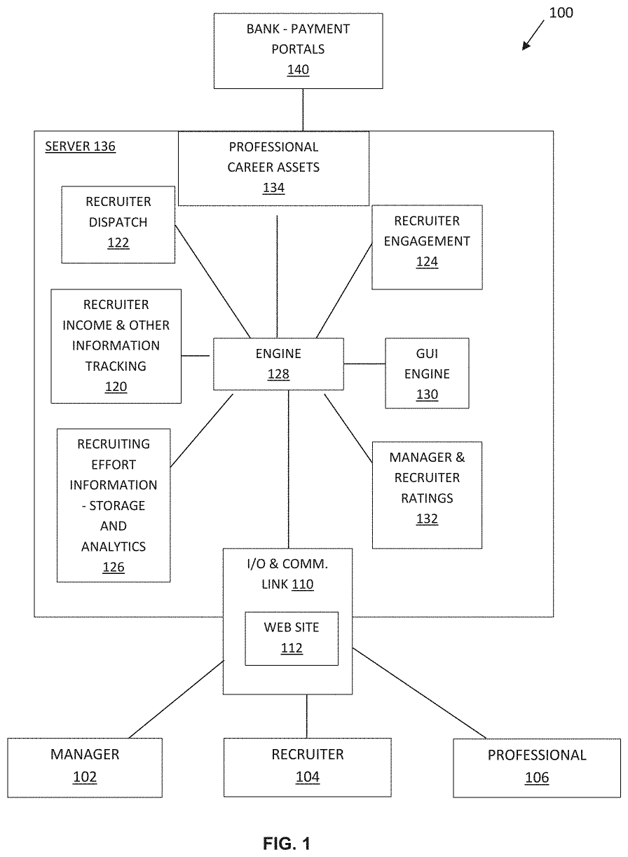

An embodiment can be understood with reference to FIG. 1, a schematic diagram of elements within and outside of the platform 100. The innovative platform includes at least one server 136 that includes at least one processor and one storage (not shown). Server 136 includes elements that each include a processor and a storage (not shown) that enables each of the elements to be a specialized processor.

More specifically, server 136 includes a recruiter income and other information tracking element 120. For example, recruiter income and tracking element 120 receives, stores, monitors, and transmits data regarding recruiter income and related informational data or metadata.

Also included is recruiter dispatch element 122. Recruiter dispatch element 122 is configured to receive and transmit recruiter dispatch communication between the hiring manager user 102 and the recruiter user 104. For instance, after the manager 102 selects on the platform to hire a specific recruiter to fulfill a job placement, the notification (e.g., dispatch) is transmitted from the manager's portal to the recruiter's portal so that the recruiter is assigned to such job officially.

Also included is a recruiter engagement element 124. Recruiter engagement element 124 is configured to receive, display, store, and analyze informational data about the level of engagement of each recruiter. For example, recruiter engagement element 124 provides engagement opportunities transmitted from managers to the recruiter. As well, recruiter engagement element 124 keeps track of the current, past, and potential job fulfillment requests by managers. For instance, parameters may be set such that the recruiter cannot accept more than an upper threshold of engagements. In an example, the upper threshold may be five or 10. The parameter is configurable and can be set by the recruiter or by an administrative element.

Also included is a recruiting effort information element 126 that includes storage and analytics capabilities. Recruiting effort information element 126 is configured to receive, display, store, and analyze informational data about the recruiting effort of each user. For example, for the manager 102, the recruiting effort information element 126 can show past, current, and potential recruiting effort information at a glance, including statistical views. For instance, the recruiting effort information element 126 can provide for the manager 102 informational data that indicates that one particular job has been on the market for a month and has not yet been fulfilled. As another example, the recruiting effort information element 126 can provide for the manager 102 informational data that indicates that one recruiter has provided more job candidates than another recruiter for the same job position. As another example, the recruiting effort information element 126 can provide for the professional 106 summary statistics about a recruiter, who has just contacted the professional 106 regarding a particular open job position.

Also included is an engine element 128. Engine element 128 is communicably connected to each of the elements of server 136 and enables communication between any of the elements within server 136.

Also included is a graphical user interface (GUI) engine 130. GUI engine 130 is configured to display the recruitment related and user related informational data for each of the manager 102, the recruiter 104, and the professional 106 is an interactive fashion. For example, GUI engine 130 is configured to allow the hiring manager 102 to view on his cell phone application the active jobs that need to be filled and to interactively invite certain recruiters to work to find candidates for the job. As another example, GUI engine 130 is configured to enable the recruiter to view an invitation to search for candidates for a specific job, to search informational data and statistics about the hiring manager who sent the invitation, and to accept or decline such invitation. As another example, GUI engine 130 is configured to enable the professional to view an invitation about a specific job from a recruiter, to search informational data and statistics about the recruiter who sent the invitation, and to accept or decline such invitation to be a job candidate.

Also included is a manager and recruiter ratings element 132. Manager and recruiter ratings element 132 is configured to receive, transmit, display, and perform statistics on manager ratings and recruiter ratings. In an embodiment, the platform prompts the recruiter 104 and/or the professional 106 for a rating of the hiring manager 102 responsive to a particular job recruitment process having been completed. For instance, the job recruitment process can terminate when the manager withdraws the job position. As another example, the job recruitment process can terminate when the job position is filled. In an embodiment, the rating is requested by the platform in real-time such that information data about the manager is kept current. Thus, the platform ensures that informational data about the manager can be shared in real-time. Similarly, the platform is configured to prompt the manager 102 and/or the professional 106 for a rating of recruiter 104 responsive to the particular job recruitment process having been completed. Thus, the platform ensures that informational data about the recruiter can be shared in real-time.

Also included is a professional career assets element 134. Professional career assets element 134 is configured to receive, transmit, store, and display career assets of the professional 106. Examples of career assets include but are not limited to resumes, letters of recommendation, referral emails, and reviews throughout their entire career. Thus, by professional career assets element 134, the professional 106 can share one current resume with one recruiter and share a different resume with a different recruiter. As another example, the professional 106 can share letters of recommendation to various recruiters.

In an embodiment, server 136 is communicable connected to bank payment portals 140 so that any of the hiring manager 102, the recruiter 104, or the professional 106 can receive funds. Such received funds can be due to referrals or placement of candidates to jobs. That is, the platform enables any of the users to cause referrals for job placements and receive the appropriate monetary reward. As well, the platform is configured to enable any of the users to initiate payment of funds via the bank 140 portal. For instance, the professional 106 might not be interested in a particular job position, but refers a different professional, e.g., a colleague, to the recruiter 104 for the job position. Should the colleague eventually become hired for the job position, the platform is configured to enable the recruiter to initial payment from his bank account to the professional 106's bank account via bank payment portals 140. In an embodiment, the platform is configured to enable any of the manager 102, the recruiter 104, and the professional 106 to add their bank account informational data for the desired institution of payment. Engine 128 facilitates the server 136 to communicate the payment parameters between the input bank account information of the manager 102, the recruiter 104, and the professional 106, respectively.

Also included is an input/output (I/O) and communication link element 110 that enables any of the users (102, 104, and 106) to communicate with the server 136. In an embodiment, the users (102, 104, and 106) communicate through a web site 112 that is controlled by input/output (I/O) and communication link element 110.

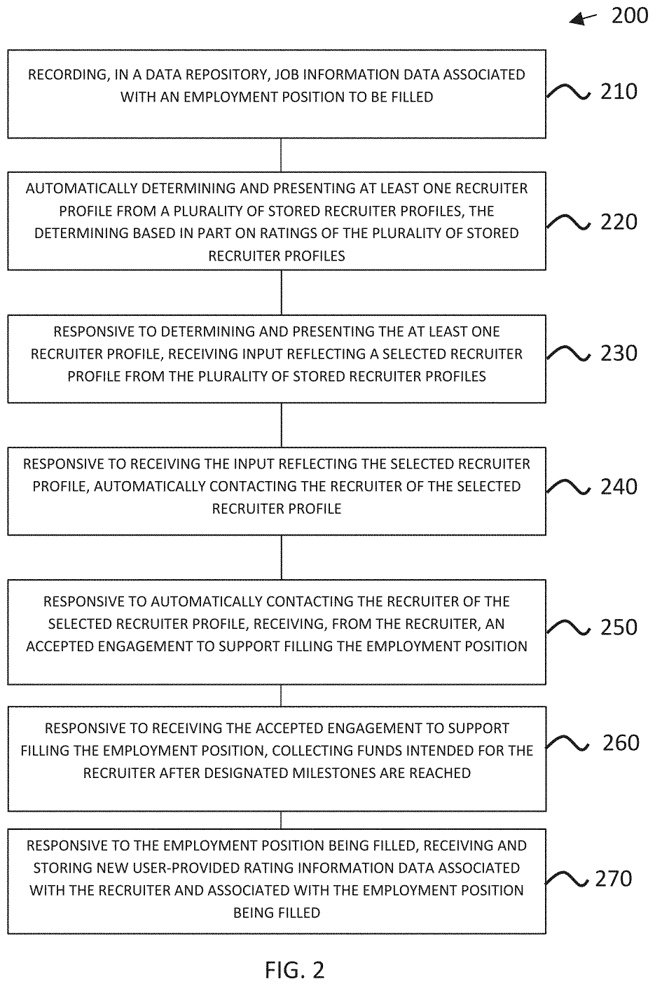

An embodiment can be understood with reference to FIG. 2, a flow diagram for creating and fulfilling an employment position from the hiring manager's system perspective 200. At step 210, the hiring manager's portal receives input about and records, in a data repository, job information data associated with an employment position to be filled. At step 220, the hiring manager's portal automatically determines and presents at least one recruiter profile from a plurality of stored recruiter profiles, the determining based in part on ratings of the plurality of stored recruiter profiles. At step 230, responsive to determining and presenting the at least one recruiter profile, the hiring manager's portal receives input reflecting a selected recruiter profile from the plurality of stored recruiter profiles. At step 240, responsive to receiving the input reflecting the selected recruiter profile, the hiring manager's portal automatically contacts the recruiter of the selected recruiter profile. At step 250, responsive to automatically contacting the recruiter of the selected recruiter profile, the hiring manager's portal receives, from the recruiter, an accepted engagement to support filling the employment position. At step 260, responsive to receiving the accepted engagement to support filling the employment position, the hiring manager's portal collects funds intended for the recruiter after designated milestones are reached. At step 270, responsive to the employment position being filled, the hiring manager's portal receives and stores new user-provided rating information data associated with the recruiter and associated with the employment position being filled.

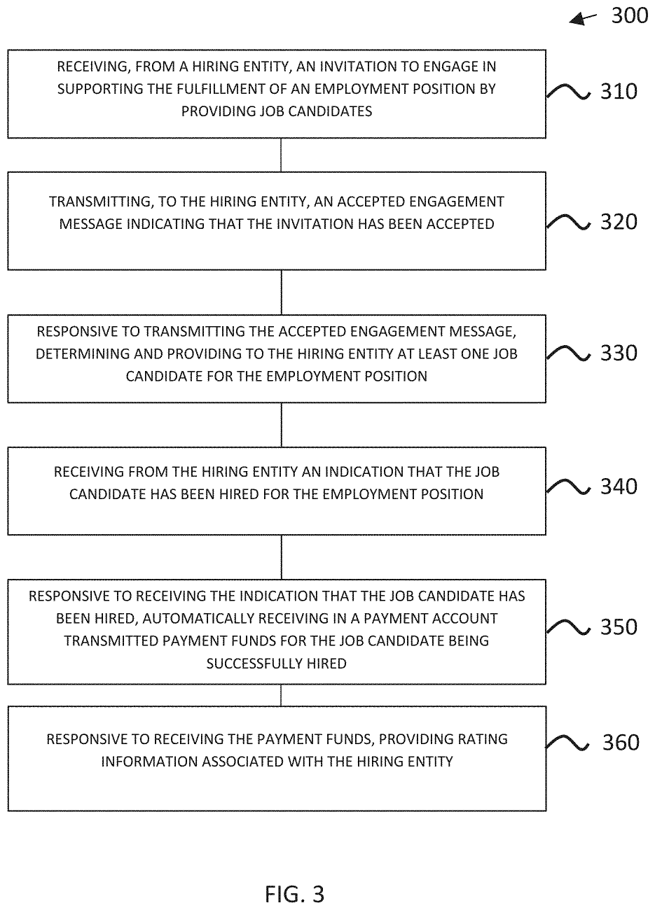

An embodiment can be understood with reference to FIG. 3, a flow diagram for being invited to and engaging in fulfilling an employment position from the recruiter's system perspective 300. At step 310, receiving at the recruiter's portal, from a hiring entity, an invitation to engage in supporting the fulfillment of an employment position by providing job candidates. At step 320, the recruiter's portal transmitting, to the hiring entity, an accepted engagement message indicating that the invitation has been accepted. At step 330, responsive to transmitting the accepted engagement message, the recruiter's portal determines and provides to the hiring entity at least one job candidate for the employment position. At step 340, receiving, by the recruiter's portal, from the hiring entity an indication that the job candidate has been hired for the employment position. At step 350, responsive to receiving the indication that the job candidate has been hired, the recruiter's portal automatically receives in a payment account transmitted payment funds for the job candidate being successfully hired. At step 360, responsive to receiving the payment funds, the user recruiter inputs a rating parameter and the recruiter's portal provides and stores rating information associated with the hiring entity.

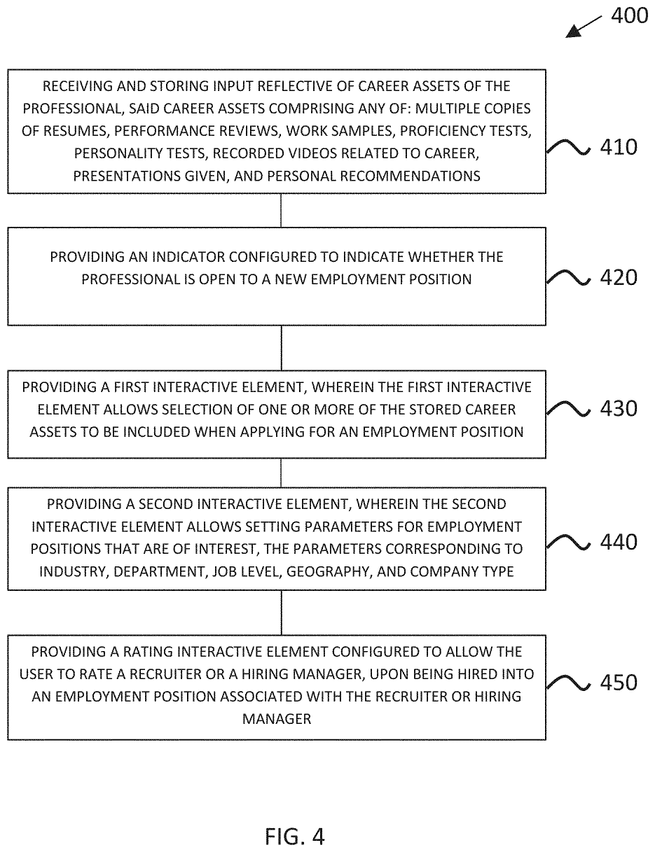

An embodiment can be understood with reference to FIG. 4, a flow diagram for handling career assets regarding employment positions and managing referrals from the professional's system perspective 400. At step 410, the professional's portal receives and stores input reflective of career assets of the professional, where the career assets can include any of: multiple copies of resumes, performance reviews, work samples, proficiency tests, personality tests, recorded videos related to career, presentations given, and personal recommendations. At step 420, the professional's portal provides an indicator configured to indicate whether the professional is open to a new employment position. At step 430, the professional's portal provides a first interactive element, where the first interactive element allows selection of one or more of the stored career assets to be included when applying for an employment position. At step 440, the professional's portal provides a second interactive element, where the second interactive element allows setting parameters for employment positions that are of interest, the parameters corresponding to industry, department, job level, geography, and company type. At step 450, the professional's portal provides a rating interactive element configured to allow the user to rate a recruiter or a hiring manager, upon being hired into an employment position associated with the recruiter or hiring manager.

### An Exemplary Implementation

An exemplary implementation is described below and illustrates functionality enabled for each of the manager user, the recruiter user, and professional user.

It should be appreciated that these functionalities are illustrative and are not meant to be limiting.

Following are exemplary functionalities provided by the platform to the manager user via the manager's portal. For example, these functions can be performed by the manager on his smartphone, digital tablet, computer, and the like.
Manager (person initiating the request—Hiring Manager or HM)
   a. Chat—drop down by job/recruiter
   b. New Job—find, select and invite recruiters
   c. Active Jobs—see and interact with the recruitment effort
      i. Header for each job
         1. Chat/text/email/phone (with recruiter)
         2. See header in platform for ideas
      ii. Job list with progress bar for each
         1. See job notes entered by the recruiter (automatically send to User via text and email)
         2. Make job notes that (Automatically sent to recruiter via text and email)
         3. Recruitment plan review and possibly approve
         4. Request updates to the Recruitment Plan
         5. Get notified when the recruiter ranks a new candidate
         6. View and edit ranked candidates and be able to make notes that trigger communications back to the recruiter
      iii. Forward candidates to others within the organization
   d. Job History
      i. job support history
      ii. See ratings given
      iii. Chat logs by recruiter
   e. Account
      i. Profile with account settings
      ii. Ratings—given and received with responses
      iii. Balances (Points and money/earnings), billing information (with modest reporting/export) and invoices
      iv. Billing contact (to receive and invoices)
      v. Payment information—cc or EFT
   f. Upgrade Now—functionality so that bigger commitments can be initiated, including, for example, the HireMojo© (San Francisco, Calif.) platform access for self service;
   g. Referral awards
      i. To managers who decided to use the platform
      ii. To professionals who were hired
      iii. Search jobs now to make professional referrals
      iv. Refer a manager to the platform
   h. Contact Customer Happiness (customer support)
Optional alternate user—same capabilities as User
   In an embodiment, the alternate user can access any of the functionalities from any of the portals to represent or view accounts of the manager, recruiter, or professional. For example, the recruiter may have a supervisor, who also requests access to the recruiter's account. Or, in an other example, the alternate user may have access to public-facing information for statistical purposes or may have limited access to data concerning a particular job, based on set parameters.
Billing Contact
   In an embodiment, the billing contact may have certain access to bank account information stored in the platform. The access privileges may be set with certain parameters.
Recruiter
   a. Header
      i. Set receive invites availability on/off (showing cap of 10—auto off)
      ii. See capacity (can support x more jobs, etc.)
      iii. See number of requests, accepts, declines, hires (earnings)
   b. New Requests!
   c. My Jobs to Fill (kept simple with toggle back functionality to full platform if needed)
      i. Candidates Forwarded (to hiring manger—these are only the ranked ones in platform)
      ii. New Candidates! These are only the ones who are in Under consideration tab, but recruiter must rank in order to be pushed into HM portal
      iii. Go to full site
   d. My earnings (and potential earnings (live jobs without hires) information)
   e. Referral awards
      i. To managers who decided to use the platform
      ii. To professionals who were hired
      iii. Search jobs now to make professional referrals
      iv. Refer a manager to the platform
   f. Account
      i. Profile with account settings
      ii. Ratings—given and received with responses
      iii. Balances (Points and money/earnings), billing information (with modest reporting/export) and invoices
      iv. Billing contact (to receive and invoices)
      v. Payment information—cc or EFT
   g. Customer Happiness (customer support)
Professional
   a. Flag for being open to a new job or not (invisibility cloak)
   b. Current jobs of interest—notifies recruiter
   c. Past jobs considered
   d. Career assets
      i. Resumes
      ii. Reviews and Commendations
      iii. Work samples
      iv. Recommendations
      v. Talents
   e. Referral awards
      i. To managers who decided to use platform
      ii. To professionals who were hired
      iii. Search jobs now to make professional referrals
      iv. Refer a manager to platform

An embodiment can be understood with reference to the following figures.

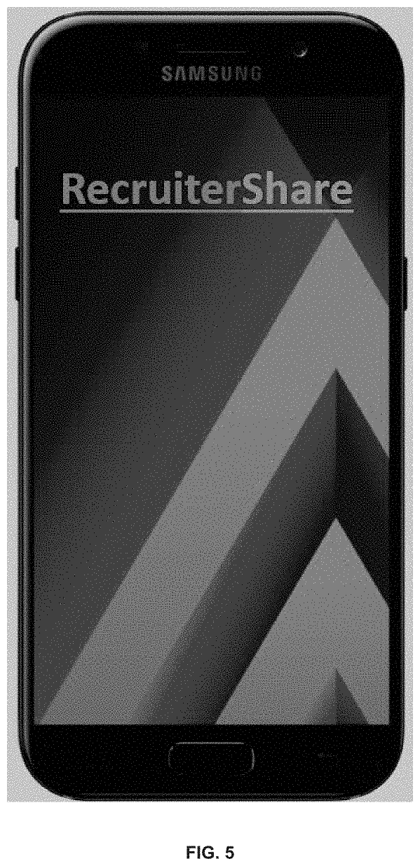

FIG. 5, a sample screen shot of the shared hiring platform application on a mobile device.

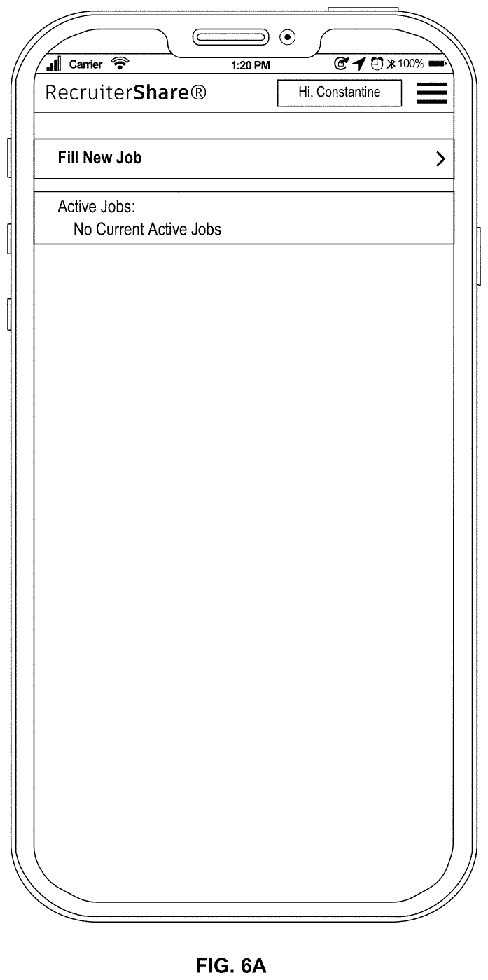

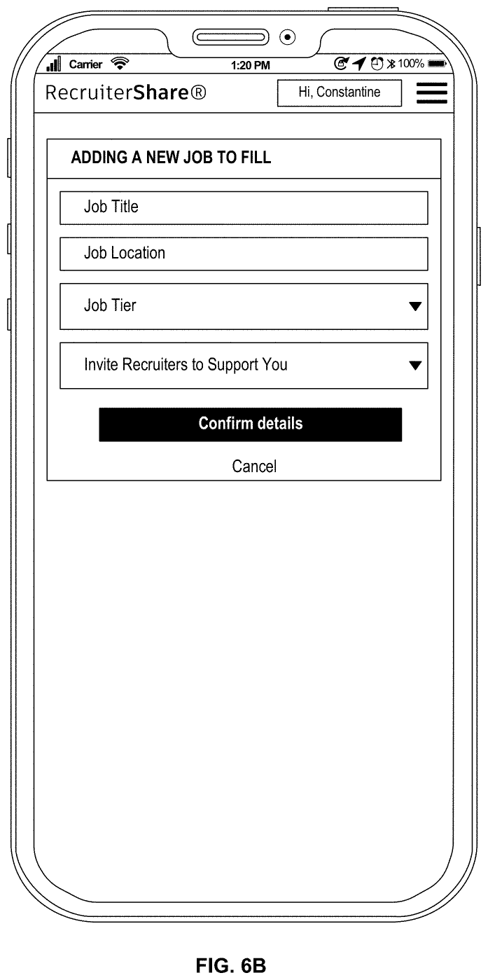

FIG. 6A is a sample screen shot of the platform's manager home screen, according to an embodiment. FIG. 6B is a sample screen shot of the platform's manager initiating a new job to be filled screen.

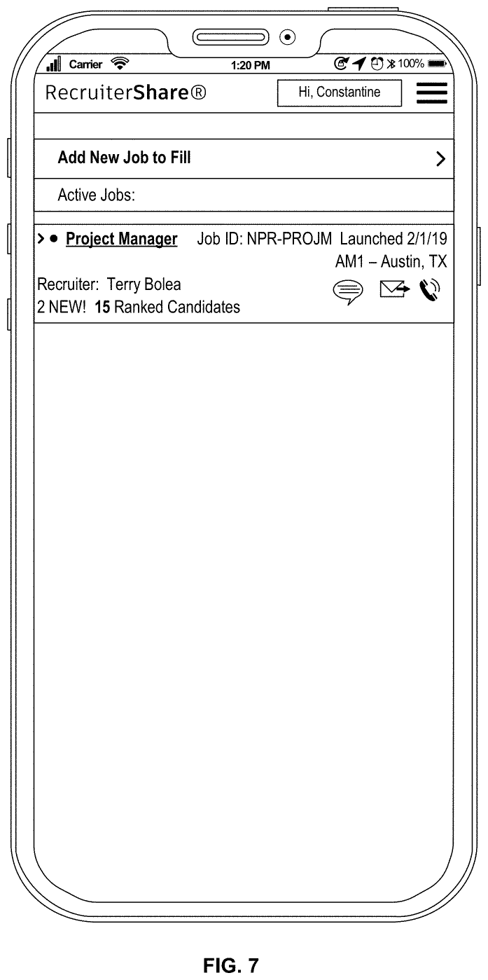

FIG. 7 is a sample screen shot of the platform's active jobs screen showing an active job, a recruiter name, and a notification of 15 ranked candidates.

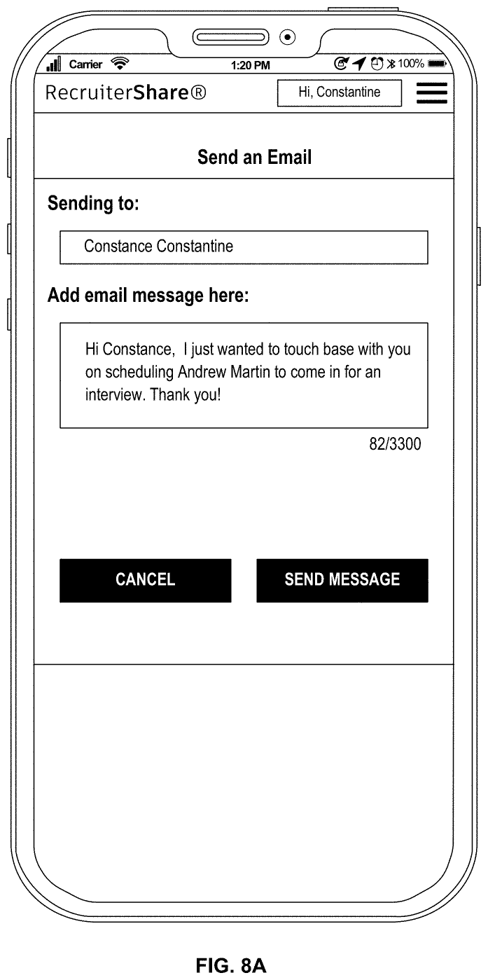

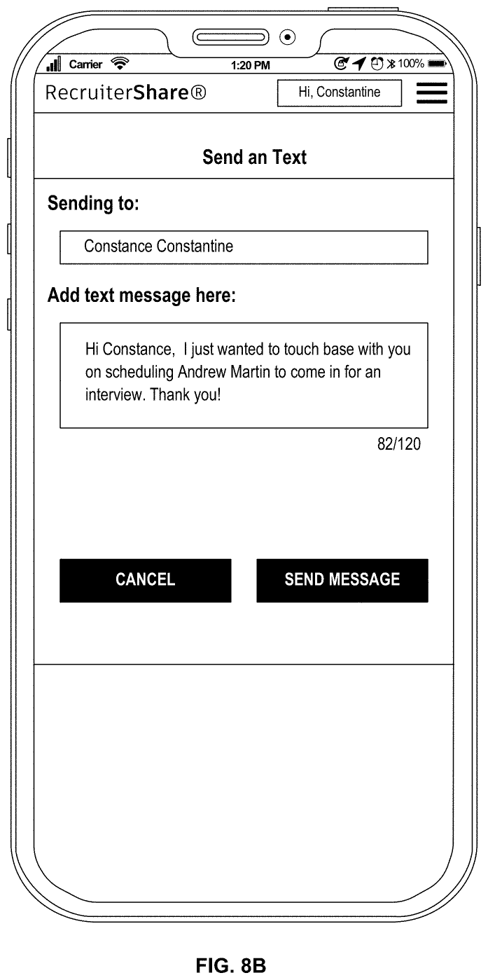

FIG. 8A is a sample screen shot of the platform's send an email screen for manager, recruiter, or professional user. FIG. 8B is a sample screen shot of the platform's send a text screen for manager, recruiter, or professional user, according to an embodiment.

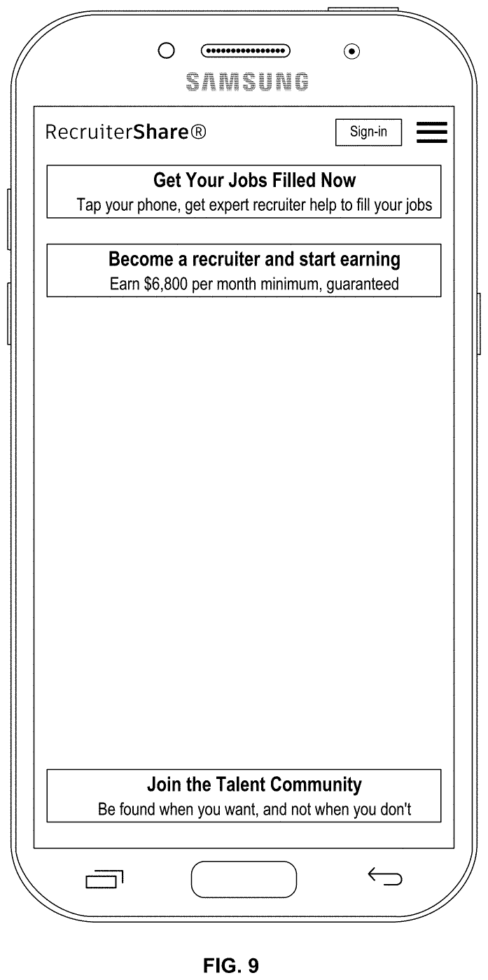

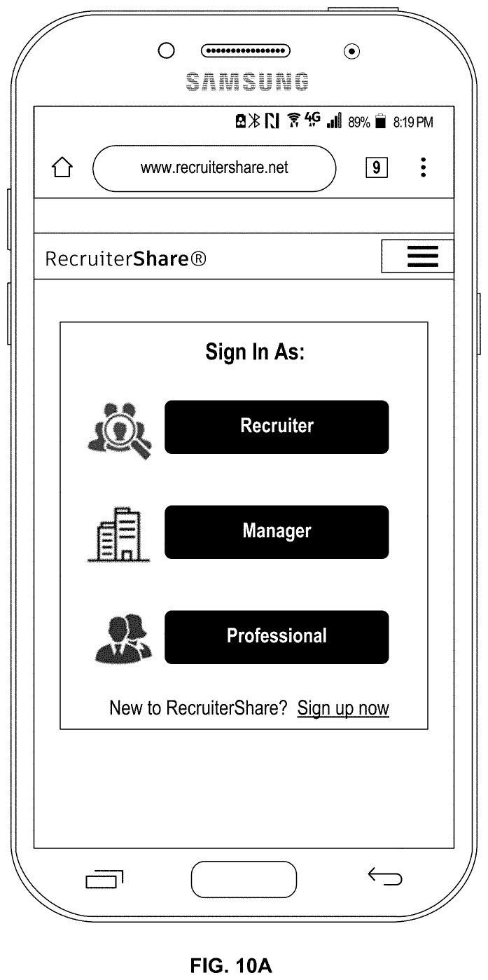

FIG. 9 is a sample screen shot of the platform's sign-in page showing high level benefits of the platform.

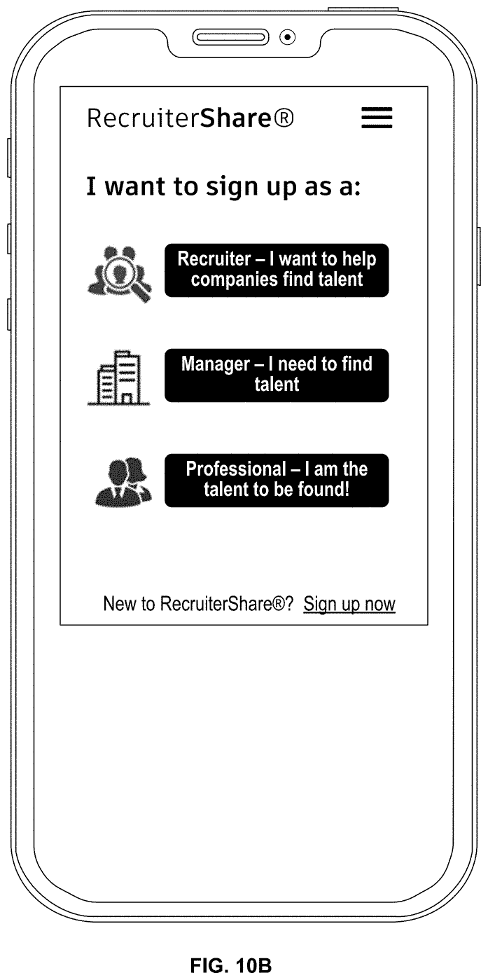

FIG. 10A-B are each a sample screen shot of the platform's sign-in screen, showing that each of the three different type of users can sign in to and use the same platform.

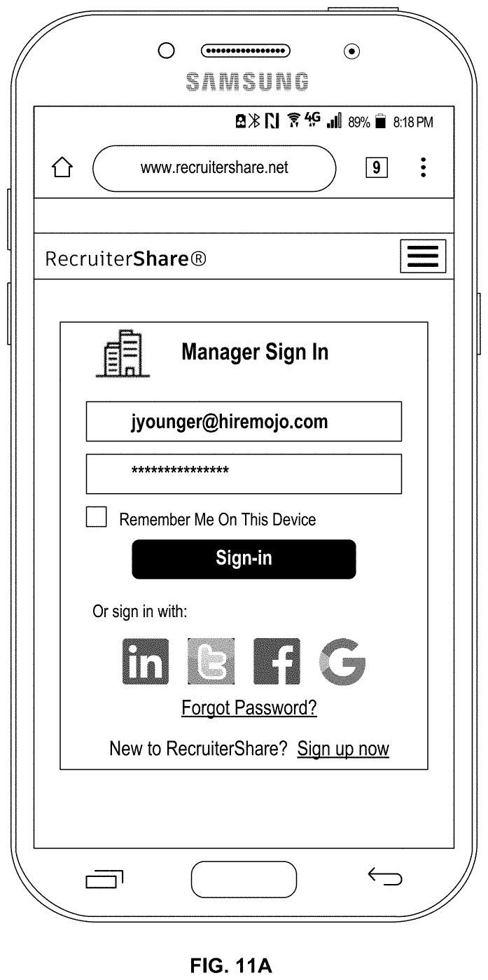

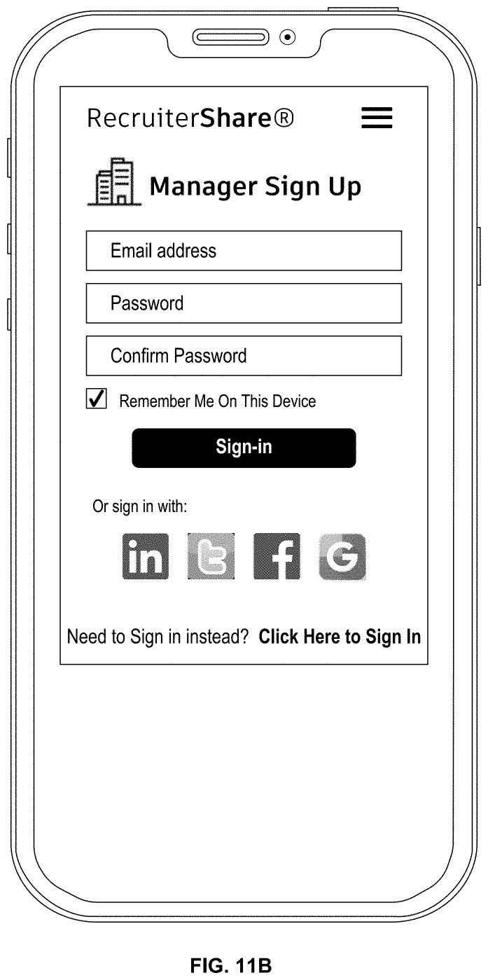

FIG. 11A-B are each a sample screen shot of the platform's hiring manager's sign-in page.

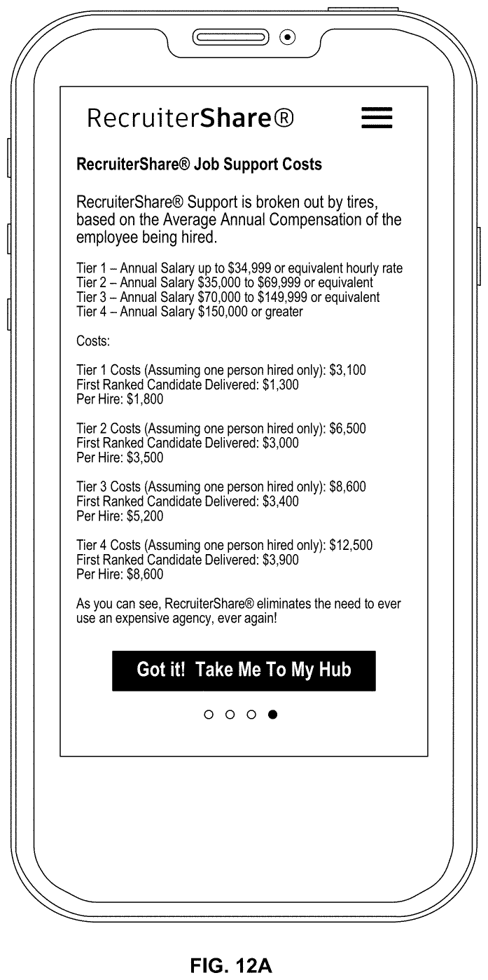

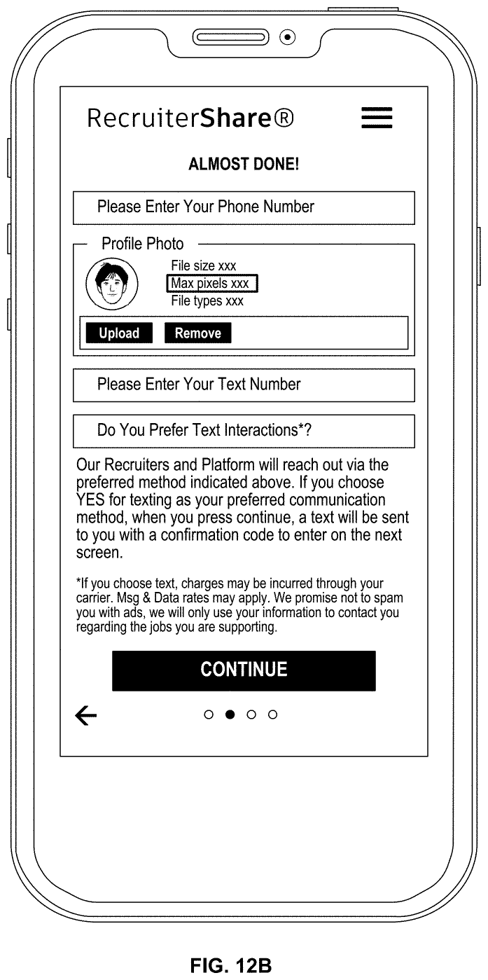

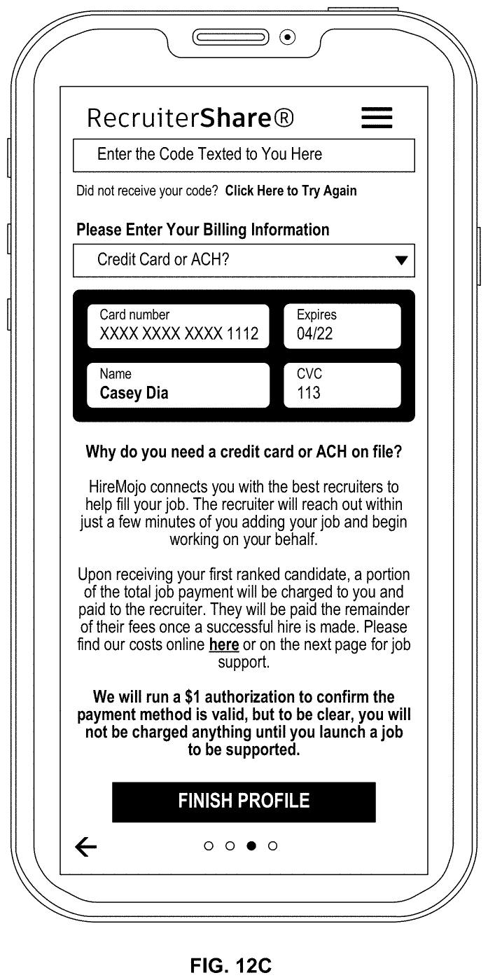

FIG. 12A is a sample screen shot of the platform's pricing page. FIG. 12B is a sample screen shot of the platform's manager profile page. FIG. 12C is a sample screen shot of the platform's billing information for the manager page.

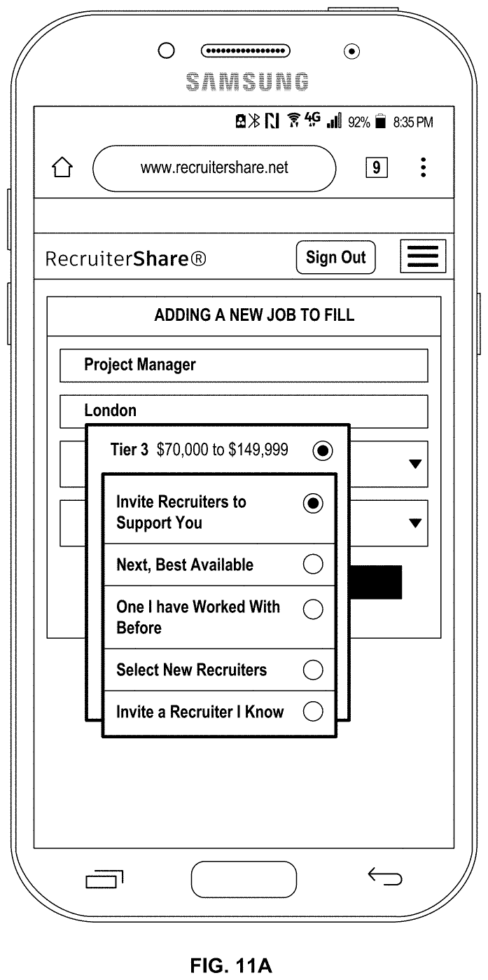

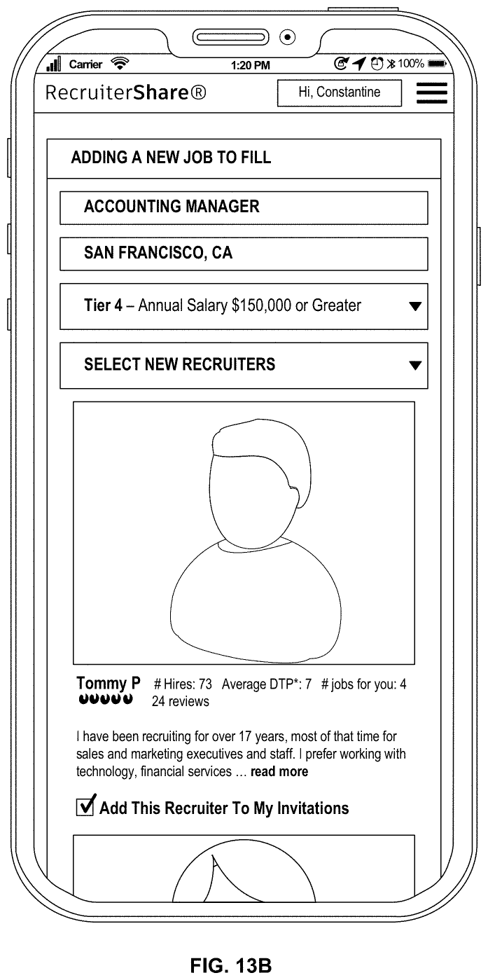

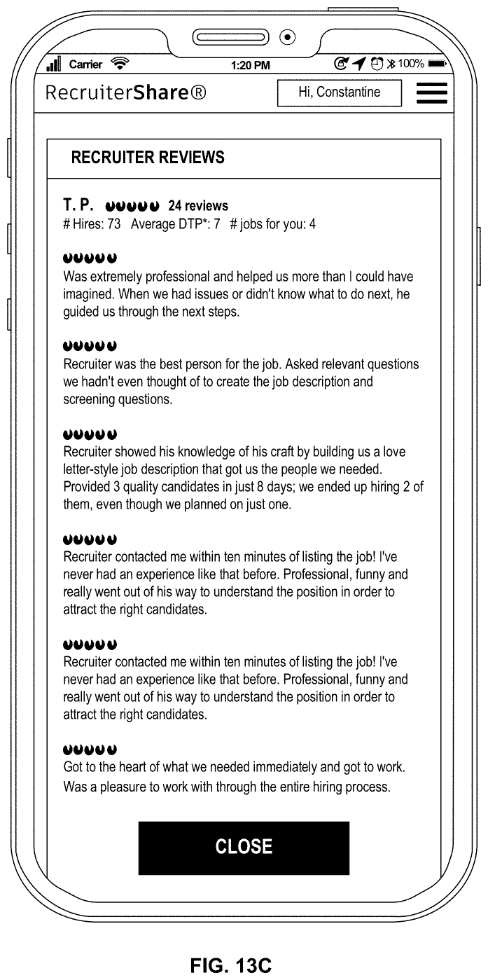

FIG. 13A is a sample screen shot of the platform's hiring manager's page for filling in information about a prospective job showing a specific job tier option being selected and options for types of recruiters to select. FIG. 13B is a sample screen shot of the manager screen showing the manager choosing recruiters to invite. FIG. 13C is a sample screen shot of the manager screen showing recruiter reviews when deciding which recruiters to invite to support the new job, according to an embodiment;

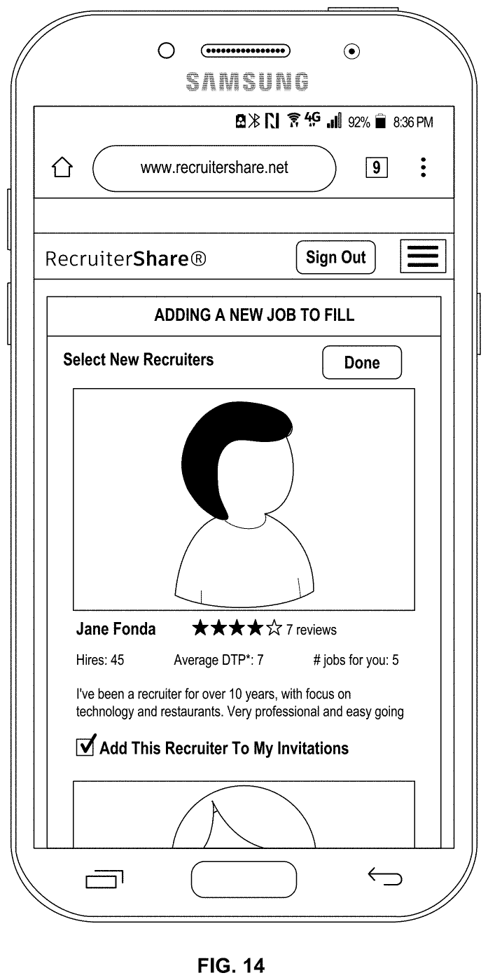

FIG. 14 is a sample screen shot of the platform's hiring manager's page for filling in information about a prospective job showing a specific recruiter from the plurality of recruiters being added to the hiring manager's recruiter invitations.

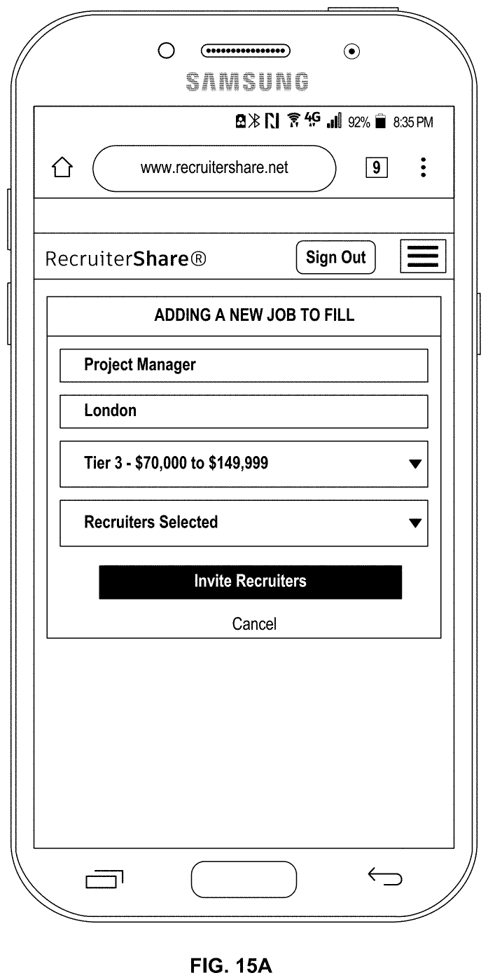

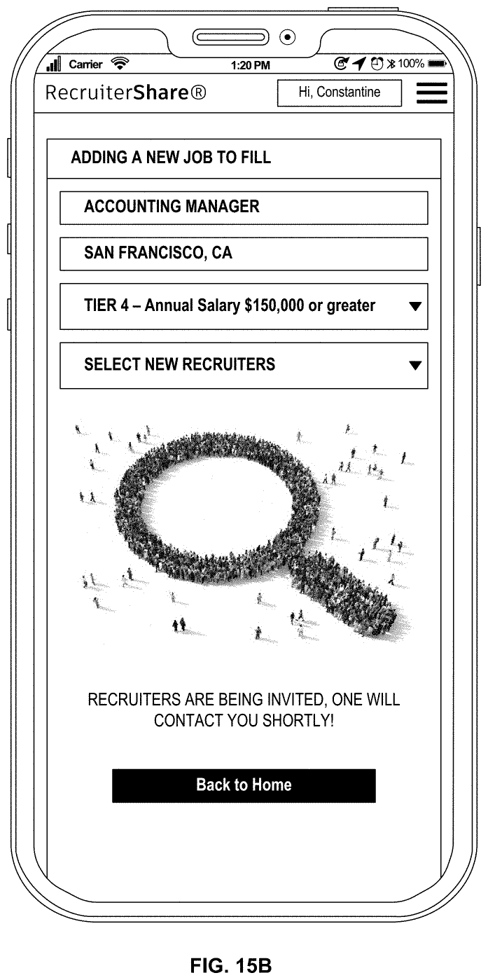

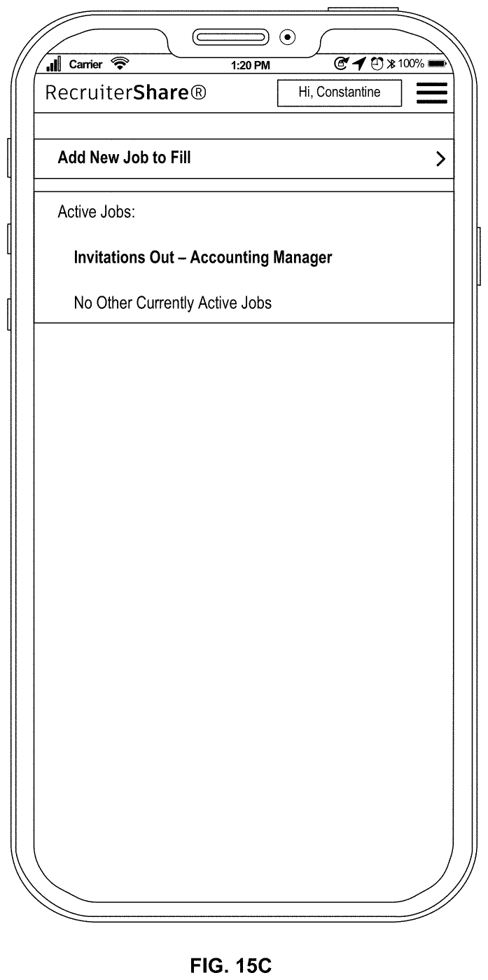

FIG. 15A is a sample screen shot of the platform's hiring manager's page for initiating invitations to recruiters to support the job. FIG. 15B is a sample screen shot of the platform's hiring manager's page for causing the recruiter invitations to be sent. FIG. 15C is a sample screen shot of the platform's hiring manager's home page showing invitations sent out.

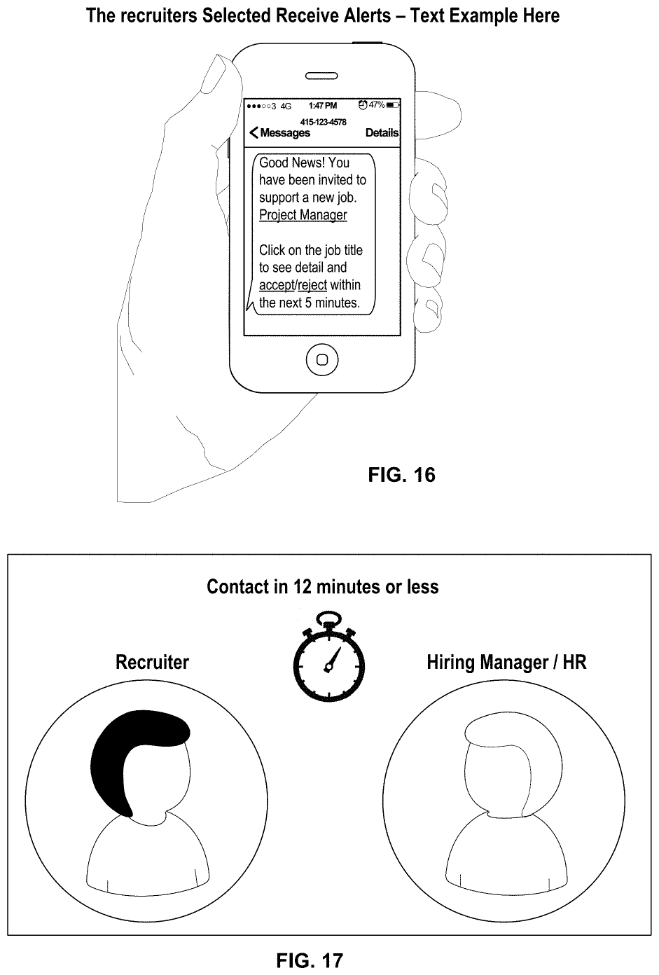

FIG. 16 shows a sample screen shot of the platform's notification page for a recruiter-user, indicating that the recruiter has received an invitation to support a new job and a link to the details.

FIG. 17 is a schematic diagram showing a recruiter user and a hiring manager user and indicating that the recruiter has 12 minutes or less to accept or deny the invitation, showing the near real-time feature provided by the platform.

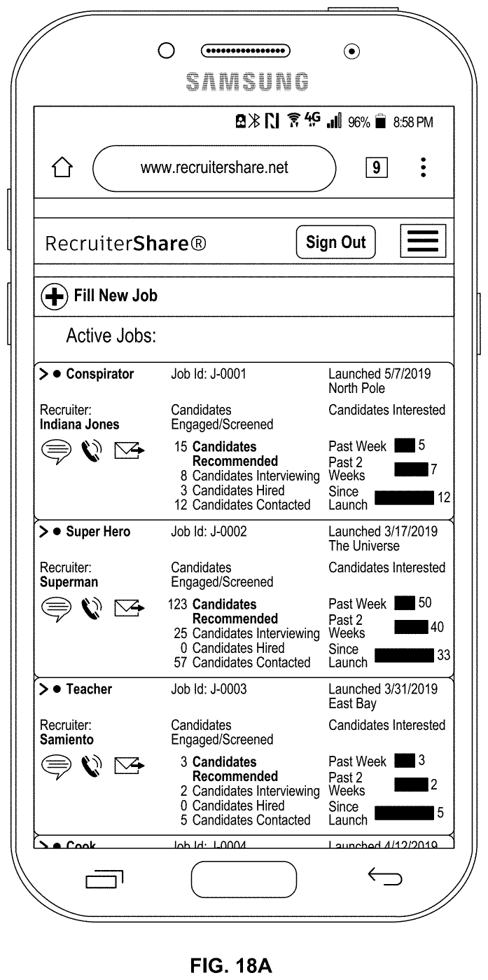

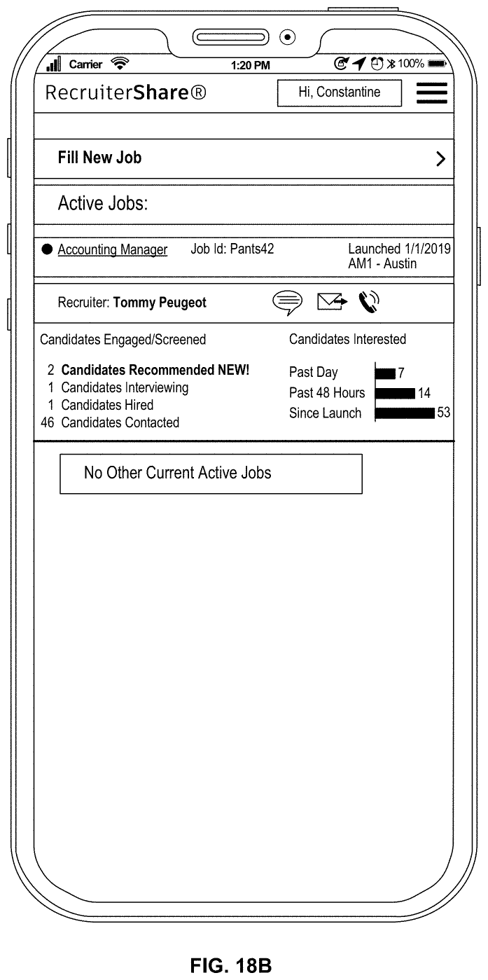

FIG. 18A is a sample screen shot of the platform's hiring manager's page showing a list of active jobs and the relevant details about each job. FIG. 18B is a sample screen shot of manager home screen showing recruiter and candidate information.

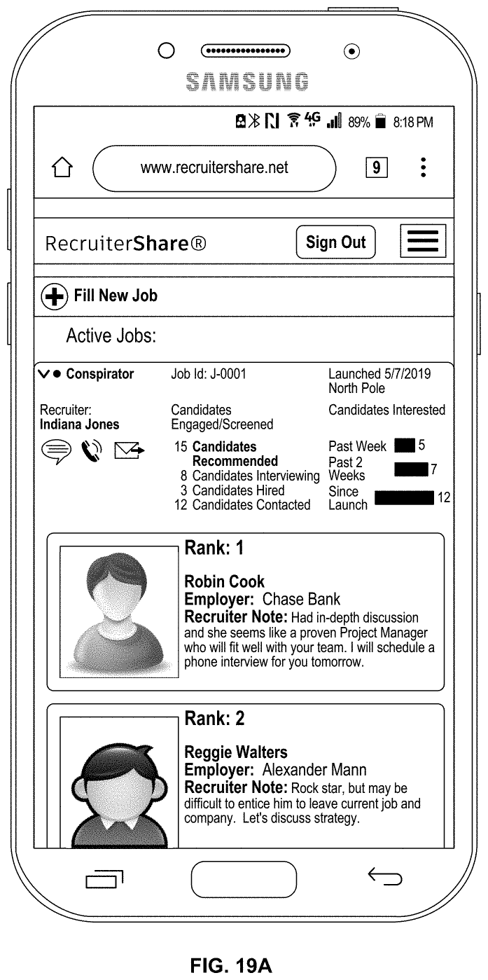

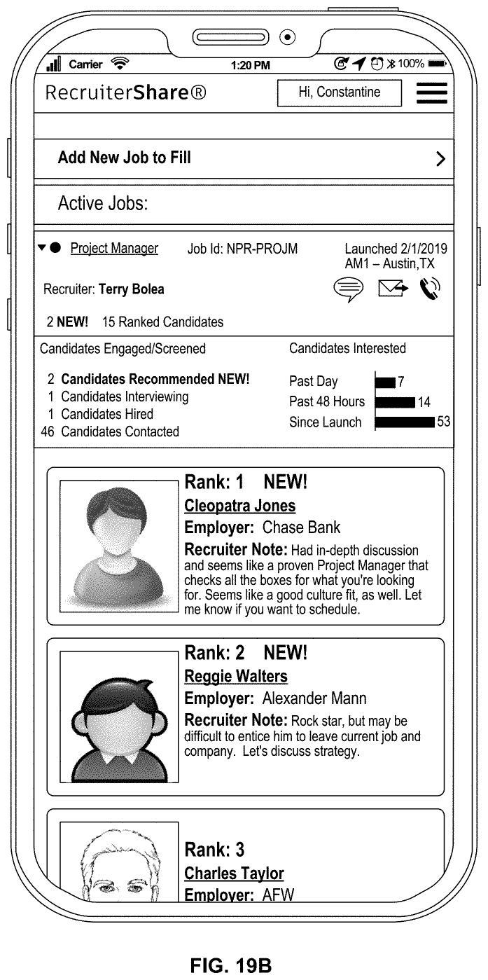

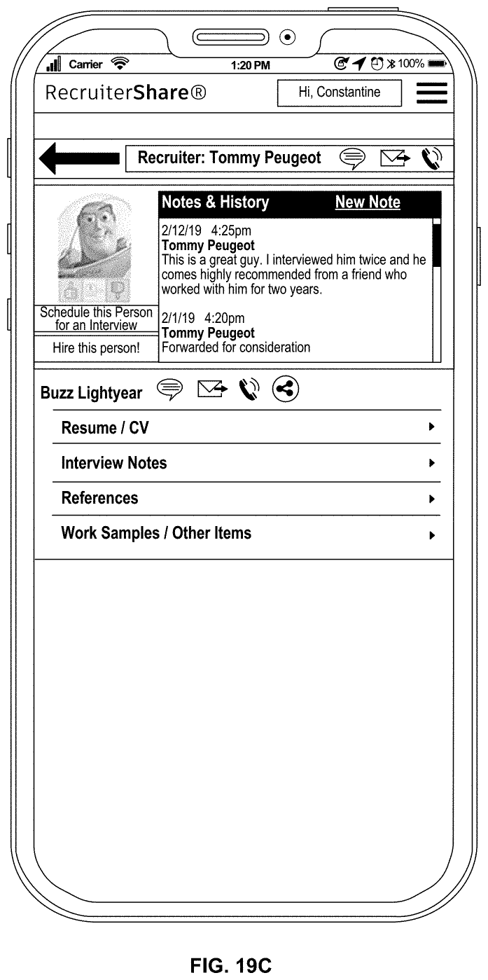

FIG. 19A is a sample screen shot of the platform's hiring manager's page showing two candidates for a specific job and relevant details related to that candidate, including notes by the recruiter. FIG. 19B is a sample screen shot of the manager views of candidates from the portal. FIG. 19C is a sample screen shot of the manager views of individual candidates in which the view shows recruiter notes and the page allows the user to contact the recruiter directly.

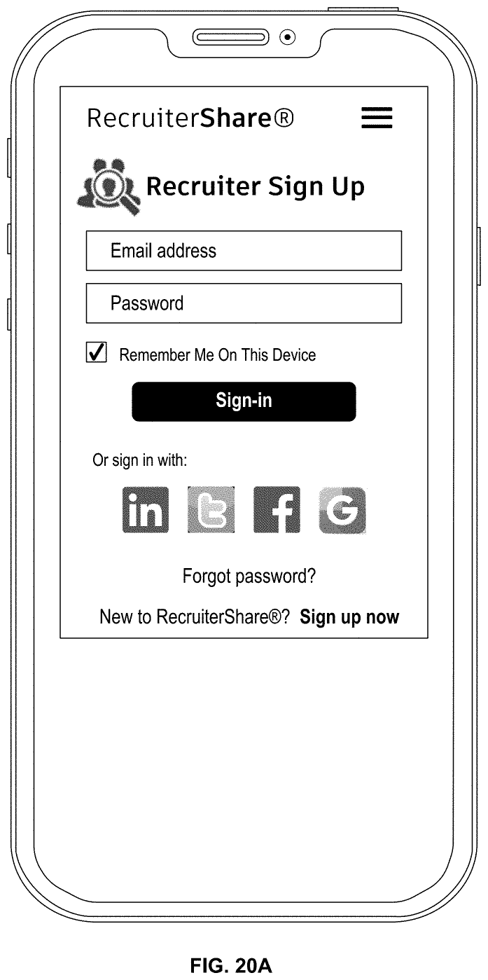

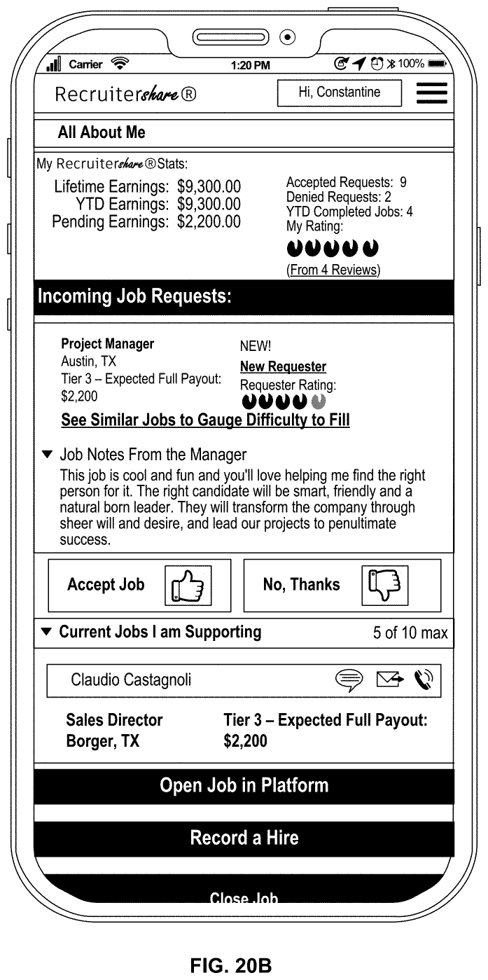

FIG. 20A is a sample screen shot of the platform's recruiter sign-in page. FIG. 20B is a sample screen shot of the platform's recruiter home page showing earnings, new requests, current jobs, access to an open new job functionality, and access to a make a referral functionality.

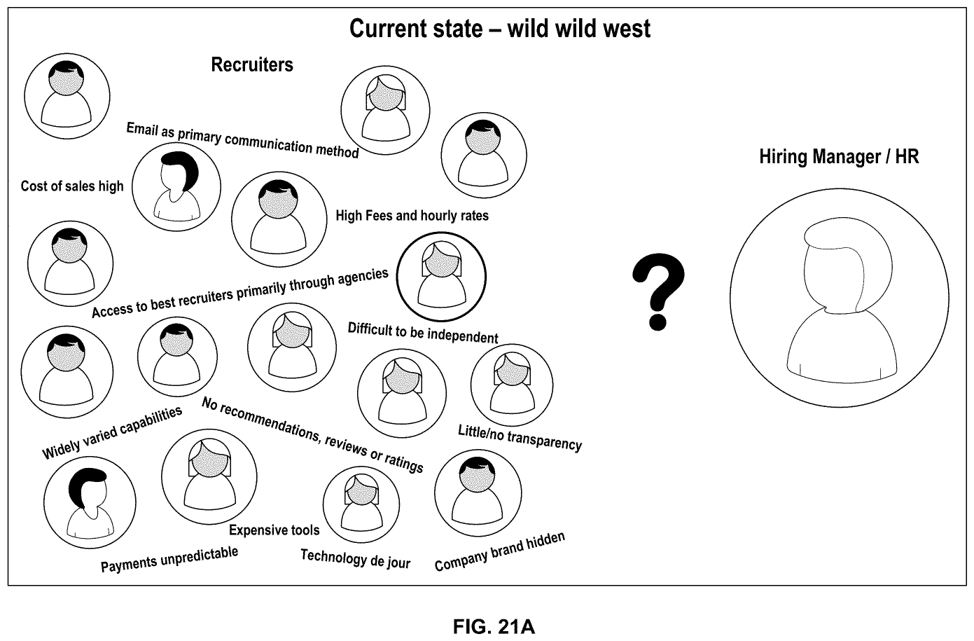

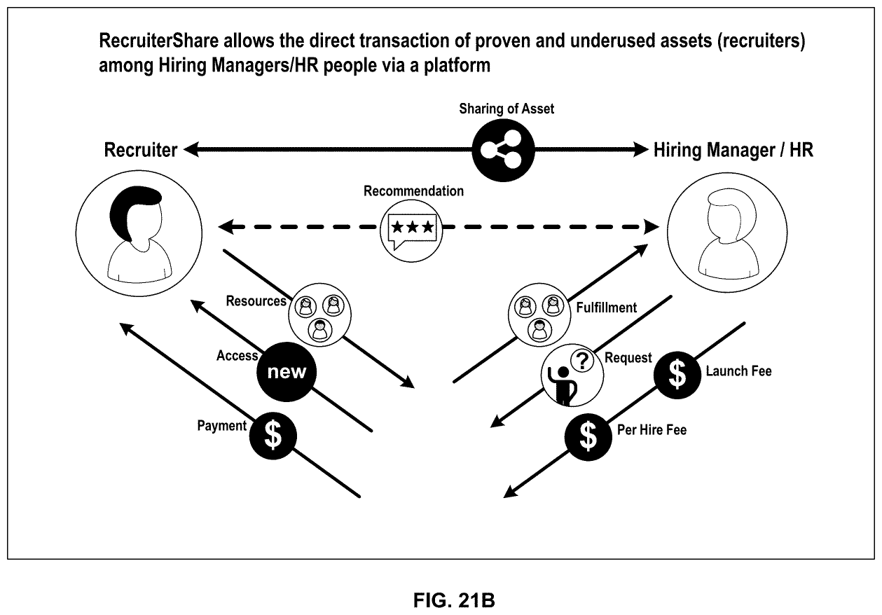

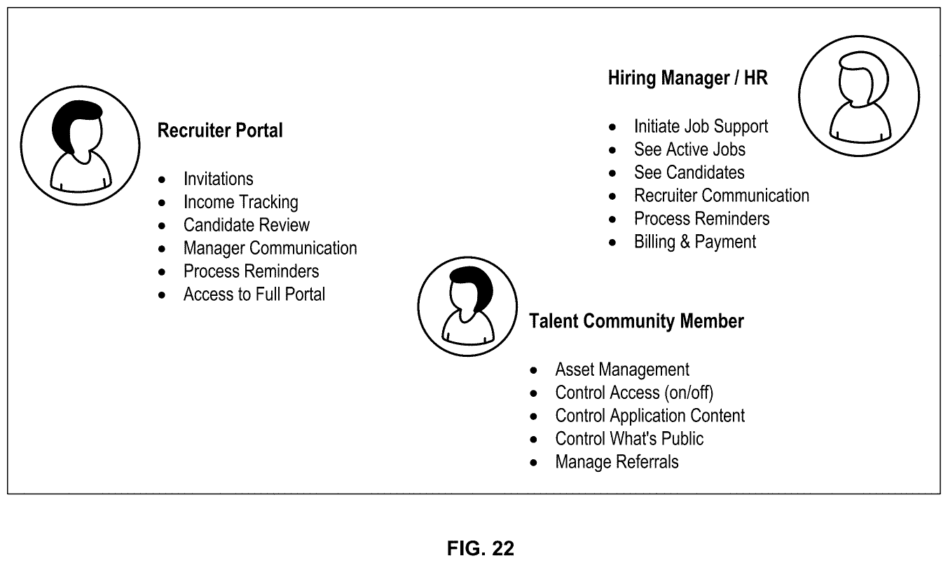

FIG. 21A is a schematic diagram showing the current state of a hiring manager and a plurality of recruiters each having specific challenges, as illustrative of a situation which the platform improves. FIG. 21B is a schematic diagram showing how the platform allows the direct transaction of proven and underused assets, e.g., recruiters, among hiring managers. FIG. 22 is a schematic diagram showing how the platform is organized into a recruiter portal, a hiring manager portal, and a talent community member, e.g., professional, portal.

In another exemplary aspect, the platform additionally includes, on an ongoing basis, storing computer events associated with the job information data, applicant flow associated with the job information data, interviews associated with the job information data, and site usage analytics associated with the job information data.

Additionally, the platform includes on an ongoing basis, monitoring the stored computer events associated with the job information data, applicant flow associated with the job information data, interviews associated with the job information data, and site usage analytics associated with the job information data; and based on the monitored computer events associated with the job information data, applicant flow associated with the job information data, interviews associated with the job information data, and site usage analytics associated with the job information data, determining that the performance of the support to fill the employment position is below a benchmark and subsequently providing suggested alternatives and course corrections.

Additionally, the platform includes wherein the job information data comprises a title, location, and compensation range of the employment position to be filled.

Additionally, the platform includes receiving a language preference and based on the received language preference, providing multi-lingual, user-friendly menu driven choices.

Additionally, the platform includes receiving and storing a recruiter payment preference and wherein transmitting the funds intended for the recruiter uses the recruiter payment preference.

Additionally, the platform includes receiving estimated costs for hiring the recruiter for finding candidates for employment position.

Additionally, the platform includes wherein designated milestones include any of: when the employment position is active or when the employment position is filled.

Additionally, the platform includes setting parameters about what employment positions might be of interest to refer other professionals based on industry, department, job level, geography and company type.

Additionally, the platform includes tracking referrals of professionals to employment positions other than said employment position to be filled by said manager.

Additionally, the platform includes tracking potential referral awards amounts and tracking when a referral of a professional results in that professional being hired.

Additionally, the platform includes paying a referral award for when a referred professional is hired into an employment position other than said employment position to be filled by said manager.

Additionally, the platform includes tracking referrals to new customers or managers and corresponding potential referral awards amounts.

Additionally, the platform includes paying a referral award for when a referred customer or manager turns into an active customer or manager.

Additionally, the platform includes wherein the invitation includes job informational data associated with the employment position.

Additionally, the platform includes completing a recruiter profile to be stored in a storage of a plurality of recruiter profiles, the recruiter profile comprising years of experience, areas of expertise, previous delivery statistics, hiring manager reviews, candidate reviews, and third-party ratings.

Additionally, the platform includes on an ongoing basis, storing computer events associated with the job information data, applicant flow associated with the job information data, interviews associated with the job information data, and site usage analytics associated with the job information data;
on an ongoing basis, monitoring the stored computer events associated with the job information data, applicant flow associated with the job information data, interviews associated with the job information data, and site usage analytics associated with the job information data; and
based on the monitored computer events associated with the job information data, applicant flow associated with the job information data, interviews associated with the job information data, and site usage analytics associated with the job information data, determining that the performance of the support to fill the employment position is below a benchmark and subsequently providing suggested alternatives and course corrections.

Additionally, the platform includes receiving a language preference and based on the received language preference, providing multi-lingual, user-friendly menu driven choices.

Additionally, the platform includes providing a payment preference and wherein the transmitted funds are received in accordance with the payment preference.

Additionally, the platform includes providing estimated earnings for finding the job candidates who are hired into the employment position.

Additionally, the platform includes responsive to receiving the invitation, presenting reviews and ratings of the hiring entity and criteria associated with the employment position to provide assistance in the decision process for accepting or rejecting the invitation.

Additionally, the platform includes presenting active, filled, unfilled and pending job search requests from a plurality of hiring entities, along with current income earned and potential earnings based on filling the jobs of the active and pending job search requests.

Additionally, the platform includes setting parameters about what employment positions might be of interest to refer other professionals based on industry, department, job level, geography and company type.

Additionally, the platform includes tracking referrals of professionals to employment positions not supported by recruiter.

Additionally, the platform includes tracking potential referral awards amounts and when a referral of a professional results in that professional being hired.

Additionally, the platform includes paying the referral award for when a referred professional is hired into an employment position not supported by recruiter.

Additionally, the platform includes tracking of referrals to new customers or managers and corresponding potential referral awards amounts.

Additionally, the platform includes paying the referral award for when a referred customer or manager turns into an active customer.

Additionally, the system is further configured to contact or notify the professional when a new employment position meeting the criteria set by the professional is met and wherein the professional is open to a new employment position.

Additionally, the system is further configured to notifying recruiters when the professional is open to a new employment position and wherein there is a match between the employment position supported by the recruiters and the desired employment position set by the professional.

Additionally, the system is further configured to allow setting parameters about employment positions of interest to refer other professionals based on industry, department, job level, geography and company type.

Additionally, the system is further configured to track referrals of professionals to employment positions.

Additionally, the system is further configured to track potential referral awards amounts and when a referral of a professional results in the referred professional being hired.

Additionally, the system is further configured to paying a referral award intended for the professional for when a referred professional is hired into an employment position.

Additionally, the system is further configured to track referrals to new customers or managers and potential referral awards amounts.

Additionally, the system is further configured to pay a referral award for when a referred customer or manager turns into an active customer.

### An Example Machine Overview

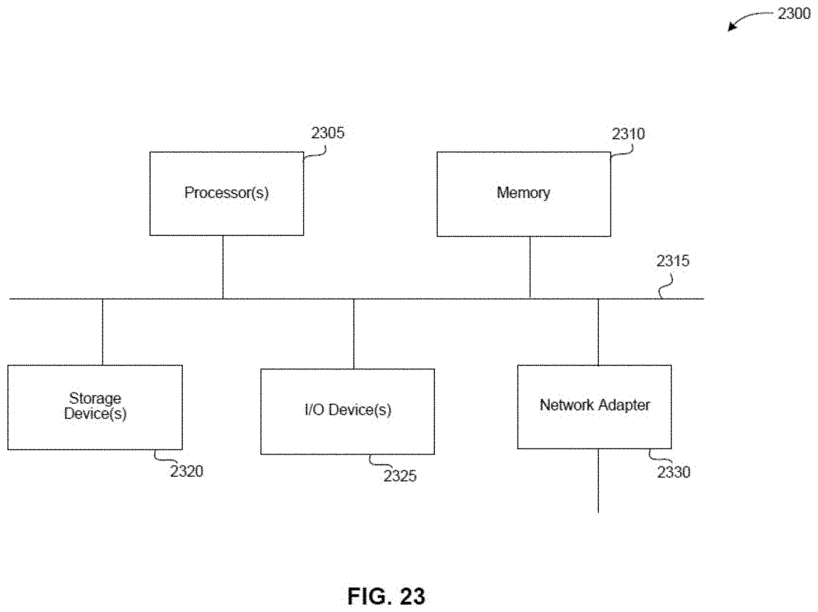

FIG. 23 is a block diagram of a computer system as may be used to implement features of the disclosed embodiments. The computer system 2300 may be used to implement any of the entities, components or services depicted in the examples of the foregoing figures (and any other components described in this specification). The computer system 2300 may include one or more central processing units (“processors”) 2305, memory 2310, input/output devices 2325 (e.g., keyboard and pointing devices, display devices), storage devices 2320 (e.g., disk drives), and network adapters 2330 (e.g., network interfaces) that are connected to an interconnect 2315. The interconnect 2315 is illustrated as an abstraction that represents any one or more separate physical buses, point to point connections, or both connected by appropriate bridges, adapters, or controllers. The interconnect 2315, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Components (IEEE) standard 1394 bus, also called “Firewire”.

The memory 2310 and storage devices 2320 are computer-readable storage media that may store instructions that implement at least portions of the described embodiments. In addition, the data structures and message structures may be stored or transmitted via a data transmission medium, such as a signal on a communications link. Various communications links may be used, such as the Internet, a local area network, a wide area network, or a point-to-point dial-up connection. Thus, computer readable media can include computer-readable storage media (e.g., “non transitory” media) and computer-readable transmission media.

The instructions stored in memory 2310 can be implemented as software and/or firmware to program the processor(s) 2305 to carry out actions described above.

In some embodiments, such software or firmware may be initially provided to the computer system 2300 by downloading it from a remote system through the computer system 2300 (e.g., via network adapter 2330).

The embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method comprising:
providing a platform that includes a computing device having a processor associated therewith, wherein the processor includes instructions for executing a method for automatically, over a network, dispatching, engaging, and paying a recruiter, the method comprising:
storing, in a data repository and by a hiring manager user, a record comprising job information data associated with an employment position to be filled;
responsive to storing the record comprising the job data information, automatically determining in real-time and presenting one or more recruiter profiles from a plurality of stored recruiter profiles, the determining based in part on ratings;
responsive to determining and presenting the one or more recruiter profiles, receiving an input signal reflecting a selected recruiter profile from the presented one or more recruiter profiles;
responsive to receiving the input signal reflecting the selected recruiter profile, automatically transmitting, over the network, to the recruiter of the selected recruiter profile, a candidate search request for finding a candidate to fill the employment position;
responsive to automatically transmitting the candidate search request to the recruiter, displaying in real-time rating informational data about the hiring manager user, and receiving, from the recruiter, an accepted engagement to support filling the employment position;
responsive to receiving the accepted engagement to support filling the employment position, collecting funds intended for the recruiter after designated milestones are reached; and
responsive to the employment position being filled, receiving and storing new user-provided rating information data associated with the recruiter and associated with the employment position being filled;
wherein one or more steps are performed on at least a processor coupled to at least a memory.

2. The method of claim 1, further comprising
on an ongoing basis, storing computer events associated with the job information data, applicant flow associated with the job information data, interviews associated with the job information data, and site usage analytics associated with the job information data;
on an ongoing basis, monitoring the stored computer events associated with the job information data, applicant flow associated with the job information data, interviews associated with the job information data, and site usage analytics associated with the job information data; and
based on the monitored computer events associated with the job information data, applicant flow associated with the job information data, interviews associated with the job information data, and site usage analytics associated with the job information data, determining that the performance of the support to fill the employment position is below a benchmark and subsequently providing suggested alternatives and course corrections.

3. The method of claim 1, wherein the job information data comprises a title, location, and compensation range of the employment position to be filled.

4. The method of claim 1, further comprising:
receiving a language preference and based on the received language preference, providing multi-lingual, user-friendly menu driven choices.

5. The method of claim 1, further comprising:
receiving and storing a recruiter payment preference and wherein transmitting the funds intended for the recruiter uses the recruiter payment preference.

6. The method of claim 1, further comprising:
receiving estimated costs for hiring the recruiter for finding candidates for employment position.

7. The method of claim 1, wherein designated milestones include any of: when the employment position is active or when the employment position is filled.

8. The method of claim 1, further comprising:
setting parameters about what employment positions might be of interest to refer other professionals based on industry, department, job level, geography and company type.

9. The method of claim 1, further comprising:
tracking referrals of professionals to employment positions other than said employment position to be filled by a manager.

10. The method of claim 1, further comprising:
tracking potential referral awards amounts and tracking when a referral of a professional results in that professional being hired.

11. The method of claim 1, further comprising:
paying a referral award for when a referred professional is hired into an employment position other than said employment position to be filled by a manager.

12. The method of claim 1, further comprising:
tracking referrals to new customers or managers and corresponding potential referral awards amounts.

13. The method of claim 1, further comprising:
paying a referral award for when a referred customer or manager turns into an active customer or manager.

14. A method comprising:
providing a platform that includes a computing device having a processor associated therewith, wherein the processor includes instructions for executing a method for automatically, over a network, dispatching, engaging, and paying and tracking income of a recruiter, the method comprising:
receiving, from a hiring entity over the network, an invitation to engage in supporting the fulfillment of an employment position by providing job candidates;
displaying in real-time rating informational data about the hiring entity;
transmitting, to the hiring entity and over the network, an accepted engagement message indicating that the invitation has been accepted;
responsive to transmitting the accepted engagement message, determining and providing to the hiring entity at least one job candidate for the employment position;
receiving from the hiring entity an indication that the job candidate has been hired for the employment position;
responsive to receiving the indication that the job candidate has been hired, automatically receiving in a payment account transmitted payment funds for the job candidate being successfully hired; and
responsive to receiving the payment funds, providing rating information associated with the hiring entity in real-time so that the rating informational data about the hiring entity is kept current;
wherein one or more steps are performed on at least a processor coupled to at least a memory.

15. The method of claim 14, wherein the invitation includes job informational data associated with the employment position.

16. The method of claim 14, further comprising:
completing a recruiter profile to be stored in a storage of a plurality of recruiter profiles, the recruiter profile comprising years of experience, areas of expertise, previous delivery statistics, hiring manager reviews, candidate reviews, and third-party ratings.

17. The method of claim 14, further comprising:
on an ongoing basis, storing computer events associated with the job information data, applicant flow associated with the job information data, interviews associated with the job information data, and site usage analytics associated with the job information data;
on an ongoing basis, monitoring the stored computer events associated with the job information data, applicant flow associated with the job information data, interviews associated with the job information data, and site usage analytics associated with the job information data; and
based on the monitored computer events associated with the job information data, applicant flow associated with the job information data, interviews associated with the job information data, and site usage analytics associated with the job information data, determining that the performance of the support to fill the employment position is below a benchmark and subsequently providing suggested alternatives and course corrections.

18. The method of claim 14, further comprising:
receiving a language preference and based on the received language preference, providing multi-lingual, user-friendly menu driven choices.

19. The method of claim 14, further comprising:
providing a payment preference and wherein the transmitted funds are received in accordance with the payment preference.

20. The method of claim 14, further comprising:
providing estimated earnings for finding the job candidates who are hired into the employment position.

21. The method of claim 14, further comprising:
responsive to receiving the invitation, presenting reviews and ratings of the hiring entity and criteria associated with the employment position to provide assistance in the decision process for accepting or rejecting the invitation.

22. The method of claim 14, further comprising:
presenting active, filled, unfilled and pending job search requests from a plurality of hiring entities, along with current income earned and potential earnings based on filling the jobs of the active and pending job search requests.

23. The method of claim 14, further comprising:
setting parameters about what employment positions might be of interest to refer other professionals based on industry, department, job level, geography and company type.

24. The method of claim 14, further comprising:
tracking referrals of professionals to employment positions not supported by recruiter.

25. The method of claim 14, further comprising:
tracking potential referral awards amounts and when a referral of a professional results in that professional being hired.

26. The method of claim 14, further comprising:
paying the referral award for when a referred professional is hired into an employment position not supported by recruiter.

27. The method of claim 14, further comprising:
tracking of referrals to new customers or managers and corresponding potential referral awards amounts.

28. The method of claim 14, further comprising:
paying the referral award for when a referred customer or manager turns into an active customer.

29. A system for managing career progression and assets for a professional based on employment positions accepted comprising:
at least one processor coupled to at least a memory;
a recording processor configured to record changes in employment positions based on input reflective of associated activity of the professional;
a receiving and storing processor configured to receive and store input reflective of career assets of the professional, said career assets comprising any of: multiple copies of resumes, performance reviews, work samples, proficiency tests, personality tests, recorded videos related to career, presentations given, and personal recommendations;
a sharing component that is communicably connected to a digital repository of recruiter profiles, the sharing component configured to share one or more current resumes with one or more recruiters associated with the recruiter profiles and share digitally stored letters of recommendation to one or more recruiters associated with the recruiter profiles;
an indicator configured to indicate whether the professional is open to a new employment position;
a first interactive element, wherein the first interactive element allows selection of one or more of the stored career assets to be included when applying for an employment position;
a second interactive element, wherein the second interactive element allows setting parameters for employment positions that are of interest, the parameters corresponding to industry, department, job level, geography, and company type; and
a rating interactive element configured to allow the user to rate a recruiter or a hiring manager, upon being hired into an employment position associated with the recruiter or hiring manager, respectively.

30. The system of claim 29, further configured to contact or notify the professional when a new employment position meeting the criteria set by the professional is met and wherein the professional is open to a new employment position.
